(19) United States
(12) Patent Application Publication
(10) Pub. No.: US 2020/0301734 A1
(43) Pub. Date: Sep. 24, 2020

(54) INFORMATION PROCESSING APPARATUS AND NON-TRANSITORY COMPUTER READABLE MEDIUM

(71) Applicant: FUJI XEROX CO., LTD., TOKYO (JP)

(72) Inventor: Yoshiharu SUZUKI, Kanagawa (JP)

(73) Assignee: FUJI XEROX CO., LTD., TOKYO (JP)

(21) Appl. No.: 16/546,306

(22) Filed: Aug. 21, 2019

(30) Foreign Application Priority Data
Mar. 20, 2019 (JP) 2019-052378

(51) Int. Cl. G06F 9/48

(52) U.S. Cl. CPC G06F 9/4843; H04L 67/42

(57) ABSTRACT

An information processing apparatus includes a receiving unit that receives a processing request for a processing target program; and a controller that receives a processing result of the processing target program processed by an external server in a case where there is a conflicting program that conflicts with the processing target program.

### CROSS-REFERENCE TO RELATED APPLICATIONS

This application is based on and claims priority under 35 USC 119 from Japanese Patent Application No. 2019-052378 filed Mar. 20, 2019.

### BACKGROUND

### (i) Technical Field

The present disclosure relates to an information processing apparatus and a non-transitory computer readable medium.

### (ii) Related Art

Japanese Unexamined Patent Application Publication (Translation of PCT Application) No. 2008-537616 discloses a system including an apparatus that communicates with plural various devices. The devices execute various kinds of programs, and the apparatus identifies and cancels conflict between at least one program and another program by an iterative process.

### SUMMARY

In a case where processing is executed in a device, a program is activated. Hereinafter, this program is referred to as a processing target program. In a case where another program different from the processing target program is present in the device and the other program conflicts with the processing target program, a trouble occurs in the processing target program or a trouble occurs in the other program. Hereinafter, the other program that conflicts with the processing target program is referred to as a conflicting program.

One way to address the above troubles is to stop the conflicting program during execution of the processing target program. However, when the conflicting program stops, a user cannot use the conflicting program while the conflicting program is being stopped, and there is a risk of occurrence of an unexpected trouble due to the stoppage.

Aspects of non-limiting embodiments of the present disclosure relate to providing an information processing apparatus and a non-transitory computer readable medium that, in a case where a program that conflicts with a processing target program is present in a device, can obtain a processing result of the processing target program without stopping the conflicting program.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a receiving unit that receives a processing request for a processing target program; and a controller that receives a processing result of the processing target program processed by an external server in a case where there is a conflicting program that conflicts with the processing target program.

### BRIEF DESCRIPTION OF THE DRAWINGS

Exemplary embodiments of the present disclosure will be described in detail based on the following figures, wherein:

FIG. 1 illustrates an outline configuration of an information processing system according to a first exemplary embodiment;

FIG. 2 is a block diagram illustrating a hardware configuration of an information processing apparatus according to the first exemplary embodiment;

FIG. 3 is a functional block diagram illustrating an example of a functional configuration of the information processing apparatus according to the first exemplary embodiment;

FIG. 4 is a flowchart illustrating a flow of processing of the information processing apparatus according to the first exemplary embodiment;

FIG. 5 is a flowchart illustrating a flow of processing in a server with which the information processing apparatus according to the first exemplary embodiment communicates;

FIG. 6 is a flowchart illustrating a flow of processing of an information processing apparatus according to a second exemplary embodiment;

FIG. 7 is a flowchart illustrating a flow of processing of the information processing apparatus according to the second exemplary embodiment;

FIG. 8 is a flowchart illustrating a flow of processing of the information processing apparatus according to the first exemplary embodiment;

FIG. 9 is a table illustrating correspondences between processing target programs and conflicting programs in information processing according to the first exemplary embodiment;

FIG. 10 is a table illustrating cancellation program presence absence information in information processing according to a third exemplary embodiment;

FIG. 11 illustrates an example of display on a display according to the second exemplary embodiment; and

FIG. 12 illustrates an example of display on the display according to the second exemplary embodiment.

### DETAILED DESCRIPTION

Exemplary embodiments of the technique of the present disclosure are described below with reference to the drawings. Identical or equivalent constituent elements and parts in the drawings are given identical reference signs. A dimension ratio in the drawings is exaggerated for convenience of description and is sometimes different from an actual ratio.

### First Exemplary Embodiment

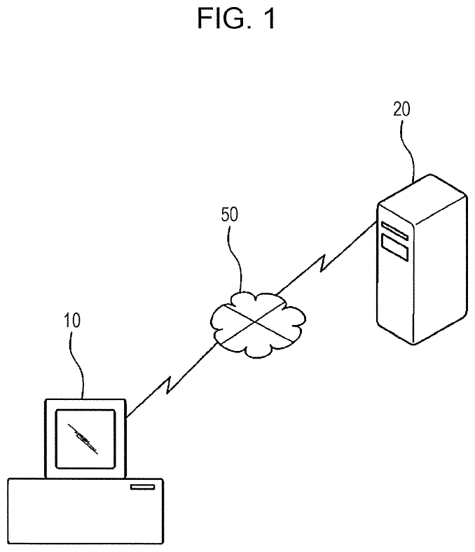

An information processing apparatus 10 according to a first exemplary embodiment of the present disclosure is described with reference to FIGS. 1 through 5 and 9.

As illustrated in FIG. 1, an information processing system according to the first exemplary embodiment includes an information processing apparatus 10 (hereinafter referred to as the “apparatus 10” as appropriate) and a server 20 that are communicably connected over a network 50.

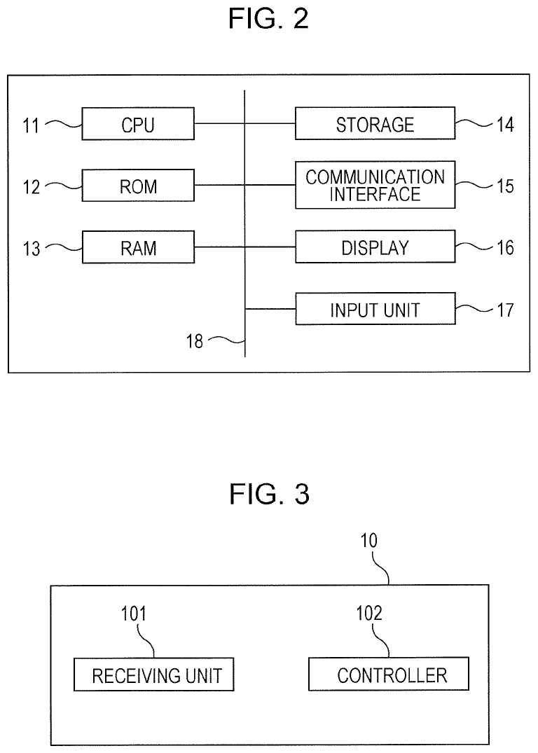

As illustrated in FIG. 2, the information processing apparatus 10 includes a central processing unit (CPU) 11, a read only memory (ROM) 12, a random access memory (RAM) 13, a storage 14, a communication interface 15, a display 17, and an input unit 16. These constituent elements are communicably connected to one another through a bus 18.

The CPU 11 is a central processing unit and executes various programs and controls each unit. That is, the CPU 11 reads out a program from the ROM 12 or the storage 14 and executes the program while using the RAM 13 as a working area. The CPU 11 controls the above constituent elements and performs various kinds of arithmetic processing in accordance with a program stored in the ROM 12 or the storage 14. In the present exemplary embodiment, an information processing program is stored in the ROM 12 or the storage 14.

In the ROM 12, various kinds of programs and various kinds of data are stored. In the RAM 13 that serves as a working area, a program or data is temporarily stored. The storage 14 includes a hard disk drive (HDD) or a solid state drive (SSD), and various kinds of programs including an operating system and various kinds of data are stored in the storage 14.

The communication interface 15 is an interface for communication with another apparatus such as the server 20. For example, a standard such as Ethernet (Registered Trademark), FDDI, or Wi-Fi (Registered Trademark) is used.

The input unit 16 includes a pointing device such as a mouse or a keyboard and is used for various kinds of input.

The display 17 is, for example, a liquid crystal display and displays various kinds of information. The display 17 may be a touch panel type display and function as the input unit 16.

Next, functional elements of the apparatus 10 and the server 20 are described.

As illustrated in FIG. 3, the apparatus 10 includes, as functional elements, a receiving unit 101 and a controller 102. The CPU 11 reads out an information processing program stored in the ROM 12 or the storage 14, loads the information processing program to the RAM 13, and then executes the information processing program, and thus each of the functional elements is realized.

The receiving unit 101 receives a processing request for a processing target program. In a case where a user desires execution of processing using the processing target program, the processing request is entered by the user, for example, by using the input unit 16 and is thus received.

In a case where there is a conflicting program that conflicts with the processing target program, the controller 102 receives a processing result of the processing target program processed by the external server 20. The “conflict” as used herein refers to an event in which execution of processing using one program causes a trouble in the other program.

Next, operation of the apparatus 10 is described.

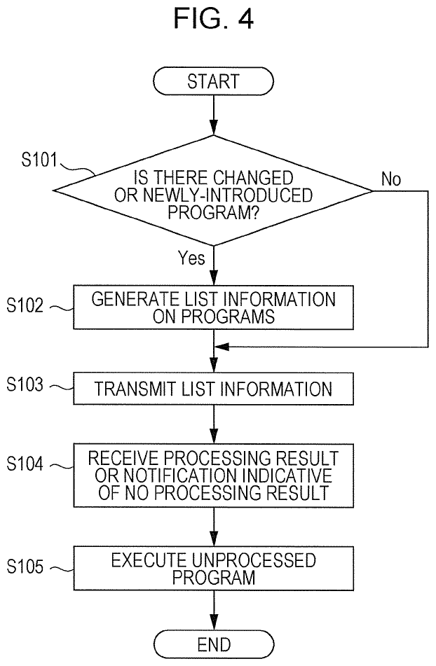

FIG. 4 is a flowchart illustrating a flow of processing in the information processing apparatus 10 according to the first exemplary embodiment. In the present exemplary embodiment, the processing is executed in a manner such that the CPU 11 reads out an information processing program from the ROM 12 or the storage 14, loads the information processing program to the RAM 13, and then executes the information processing program. The processing illustrated in FIG. 4 is executed when a processing request for a processing target program is received from a user.

In step S101, the CPU 11 serving as the controller 102 determines whether or not there is a changed or newly-introduced program other than the processing target program for which the processing request has been received by the receiving unit 101. The “changed or newly-introduced” as used herein refers to change or new introduction from a time of last receipt of a processing request for a similar processing target program by the receiving unit 101.

In a case where there is no past history of receipt of a processing request for a similar processing target program, the CPU 11 may determine whether or not change or new introduction has been made from a time of introduction of the processing target program into the apparatus 10.

In step S102, in a case where there is a changed or newly-introduced program (YES in step S101), the CPU 11 generates list information on a list of other programs. Then, the CPU 11 shifts the processing to step S103. The “list information” as used herein is information on a list of the processing target program and other programs introduced into the apparatus 10.

Meanwhile, in a case where there is no changed or newly-introduced program (NO in step S101), the CPU 11 shifts the processing to step S103.

According to the above processing, the CPU 11 generates the list information on a list of other programs only when needed. That is, generation of the list information is less frequent than processing in which the list information is generated every time.

In step S103, the list information generated in step S102 is transmitted to the external server 20. In a case where there is no changed or newly-introduced program (NO in step S101), the CPU 11 transmits past list information stored in the storage 14 to the external server 20. The “past list information” as used herein is list information that is generated when a processing request for a similar program is received last time and is stored in the storage 14. The, the CPU 11 shifts the processing to step S104.

In step S104, the CPU 11 receives a processing result of the processing target program or a notification indicative of no processing result from the external server 20 over the network 50. The “notification indicative of no processing result” is a notification given by the server 20 in a case where it is determined that a conflicting program that conflicts with the processing target program is not included in the list information generated in step S102. Then, the CPU 11 shifts the processing to step S105.

In step S105, the CPU 11 executes an unprocessed program. The “unprocessed program” is a processing target program for which a processing result has not been provided by the server 20. Then, the CPU 11 finishes the processing illustrated in FIG. 4.

Next, operation of the server 20 is described. The functional elements of the server 20 are basically similar to the functional elements of the apparatus 10, and therefore description thereof is omitted. The following processing in the server 20 is also performed in a manner such that a CPU mounted in the server 20 reads out an information processing program from a ROM or a storage, loads the information processing program to the RAM, and then executes the information processing program.

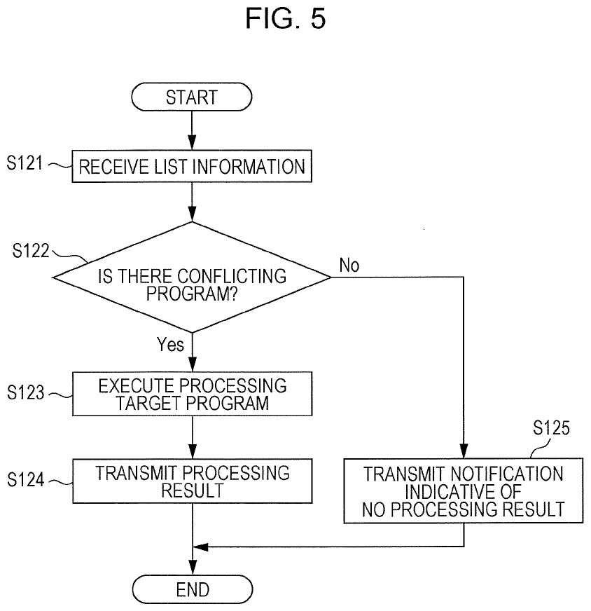

FIG. 5 is a flowchart illustrating a flow of processing in the server 20 with which the apparatus 10 according to the first exemplary embodiment communicates.

In step S121, the server 20 receives list information transmitted by the apparatus 10. In step S122, the server 20 determines whether or not a list of programs in the received list information includes a conflicting program that conflicts with a processing target program for which execution has been requested in the information processing apparatus 10. In a case where the list information includes the conflicting program (YES in step S122), the server 20 shifts the processing to step S123. In step S123, the server 20 executes processing of the processing target program. Then, the server 20 shifts the processing to step S124.

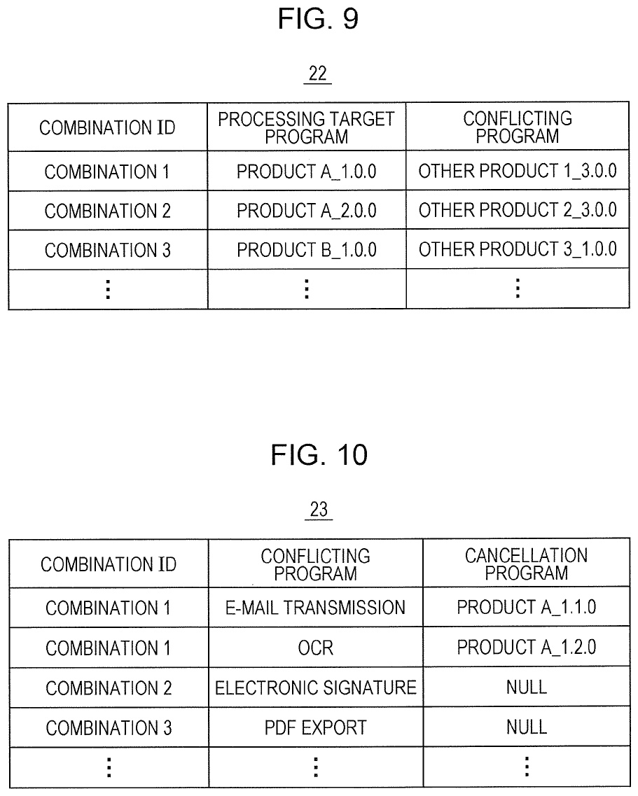

Whether or not the processing target program and a program in the list information conflict with each other is determined on the basis of a table 22 (see FIG. 9) stored in advance in the server 20. As illustrated in FIG. 9, the table 22 shows correspondences between processing target programs and conflicting programs that conflict with the processing target programs.

In step S124, a processing result of the processing target program executed in step S123 is transmitted to the apparatus 10 over the network 50. Then, the processing in the server 20 is finished.

Meanwhile, in a case where it is determined in step S122 that there is no conflicting program (No in step S122), the server 20 shifts the processing to step S125. In step S125, the server 20 transmits a notification indicative of no processing result to the apparatus 10 over the network 50. Then, the processing in the server 20 is finished.

### Second Exemplary Embodiment

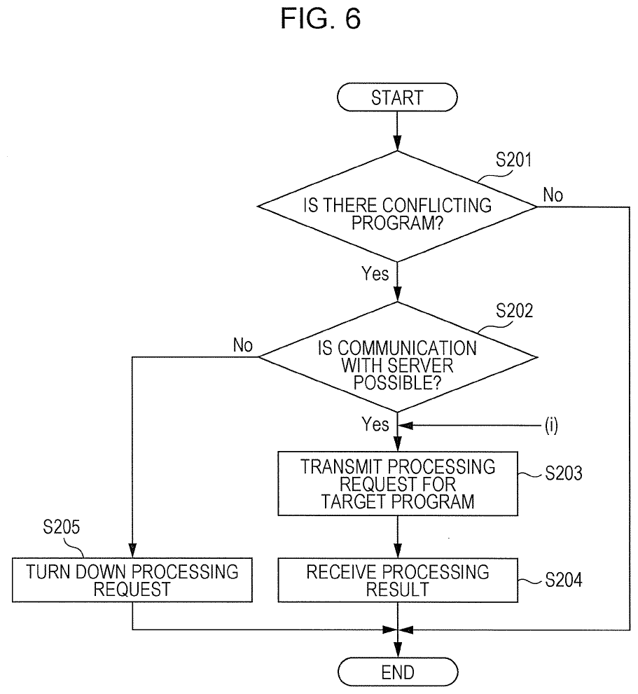

An information processing apparatus 10 according to a second exemplary embodiment of the present disclosure is described with reference to FIGS. 6, 7, 11, and 12. The information processing apparatus and an information processing system according to the second exemplary embodiment are modifications of the information processing apparatus and the information processing system according to the first exemplary embodiment, and therefore identical contents are given identical reference signs, and repeated description thereof is omitted as appropriate.

Operation of the apparatus 10 according to the second exemplary embodiment is described below.

FIG. 6 is a flowchart illustrating a flow of processing in the information processing apparatus 10 according to the second exemplary embodiment. In the present exemplary embodiment, the processing is performed in a manner such that a CPU 11 reads out an information processing program from a ROM 12 or a storage 14, loads the information processing program to a RAM 13, and then executes the information processing program.

In step S201, when a receiving unit 101 receives a processing request for a processing target program, the CPU 11 serving as a controller 102 determines whether or not a program other than the processing target program received by the receiving unit 101 conflicts with the processing target program.

Then, in a case where the program other than the processing target program received by the receiving unit 101 conflicts with the processing target program (YES in step S201), the CPU 11 shifts the processing to S202.

Meanwhile, in a case where the program other than the processing target program received by the receiving unit 101 does not conflict with the processing target program (No in step S201), the CPU 11 serving as the controller 102 finishes the processing illustrated in FIG. 6.

In step S202, in a case where communication with the server 20 is not possible (NO in step S202), the CPU 11 shifts the processing to step S205.

In step S205, the CPU 11 performs processing for turning down the request for the processing target program for which it is determined in S201 that there is a conflicting program. Then, the CPU 11 finishes the processing illustrated in FIG. 6.

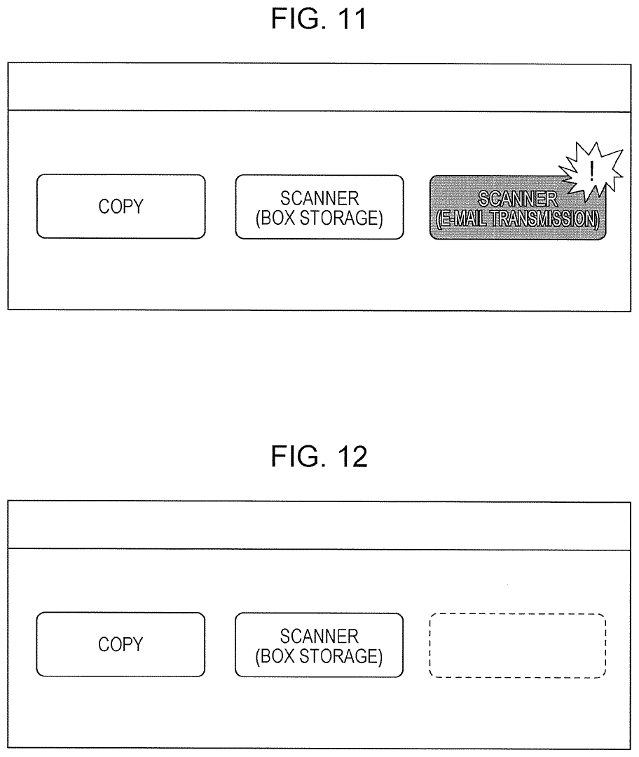

Examples of a method of the “processing for turning down the request for the processing target program” include a method for returning error processing when the receiving unit 101 receives the program processing request and a method for displaying information indicating that the processing request is not received on a display 17 when the receiving unit 101 receives the program processing request. Examples of the method for displaying information indicating that the processing request is not received on the display 17 include a method for changing color and adding a sign such as “I” to a button for execution of a specific program (a scanner (e-mail transmission) button in FIG. 11) as illustrated in FIG. 11. Alternatively, it is also possible to employ a method for hiding a generally-displayed button of a specific program as illustrated in FIG. 12.

Meanwhile, in step S202, in a case where communication with the server 20 is possible (YES in step S202), the CPU 11 shifts the processing to step S203.

In step S203, the CPU 11 transmits the processing request for the processing target program to the server 20 over the network 50. Then, the CPU 11 shifts the processing to step S204.

In step S204, the CPU 11 receives a processing result of the processing target program for which processing has been executed in the server 20. Then, the CPU 11 finishes the processing illustrated in FIG. 6.

According to such processing, in a case where there is no program that conflicts with the processing target program, communication with the server 20 is not performed, and therefore communication can be less frequent than a case where communication with the server 20 is performed irrespective of whether there is conflict.

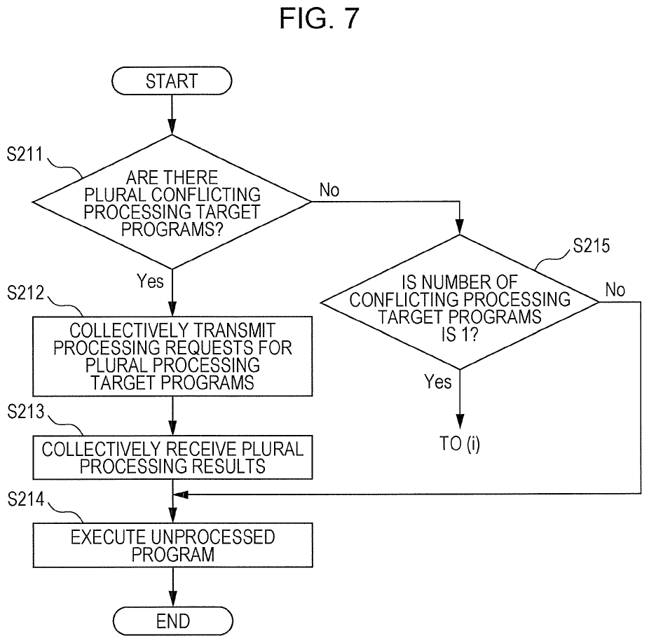

Furthermore, in the present exemplary embodiment, processing illustrated in FIG. 7 may be added in order to reduce the number of times of communication between the apparatus 10 and the server 20.

FIG. 7 is a flowchart illustrating a flow of additional information processing in the information processing apparatus 10 according to the second exemplary embodiment.

In the processing illustrated in FIG. 7, when the receiving unit 101 receives a processing request for a processing target program, the CPU 11 determines in step S211 whether or not there are plural conflicting programs. In a case where there are plural conflicting programs (YES in step S211), the CPU 11 shifts the processing to step S212.

In step S212, the CPU 11 collectively transmits processing requests for the plural processing programs to the server 20. Then, the CPU 11 shifts the processing to step S213.

In step S213, the CPU 11 collectively receives processing results of the plural processing programs for which processing has been executed by the server 20. Then, the CPU 11 shifts the processing to step S214.

In step S214, the CPU 11 executes processing of an unprocessed program (i.e., a processing program that does not conflict with other programs). Then, the CPU 11 finishes the processing illustrated in FIG. 7.

In step S211, in a case where plural conflicting programs are not present (NO in step S211), the CPU 11 shifts the processing to step S215. In step S215, the CPU 11 determines whether or not the number of conflicting programs is 1. In a case where the number of conflicting programs is 1 (YES in step S215), the CPU 11 shifts the processing to (i) illustrated in FIG. 6.

Meanwhile, in step S215, in a case where the number of conflicting programs is not 1 (NO in step S215), the CPU 11 shifts the processing to step S214.

By thus collectively transmitting and receiving processing requests and processing results of plural programs, the number of times of communication between the apparatus 10 and the server 20 can be reduced as compared with a case where the processing requests and processing results are separately transmitted and received.

### Third Exemplary Embodiment

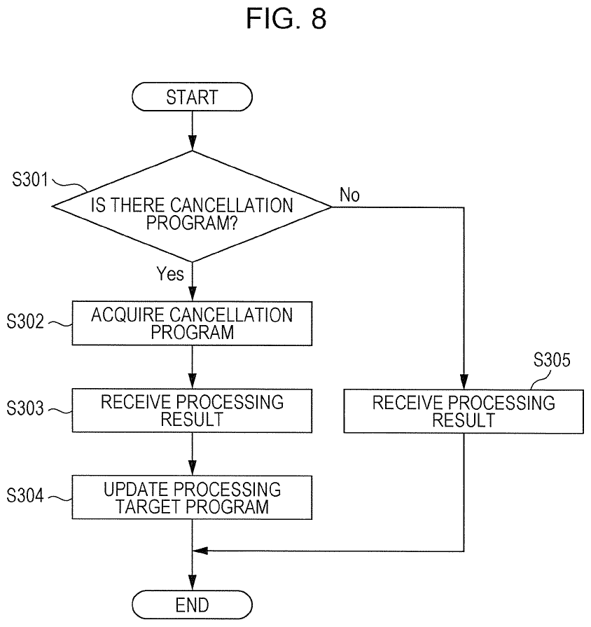

An information processing apparatus 10 according to a third exemplary embodiment of the present disclosure is described with reference to FIGS. 8 and 10. The information processing apparatus and an information processing system according to the third exemplary embodiment are modifications of the information processing apparatus and the information processing system according to the first exemplary embodiment and the second exemplary embodiment, and therefore identical contents are given identical reference signs, and repeated description thereof is omitted as appropriate.

Operation of the apparatus 10 according to the third exemplary embodiment is described below.

FIG. 8 is a flowchart illustrating a flow of information processing in the information processing apparatus 10 according to the third exemplary embodiment. In the present exemplary embodiment, the information processing is performed in a manner such that a CPU 11 reads out an information processing program from a ROM 12 or a storage 14, loads the information processing program to a RAM 13, and then executes the information processing program.

First, in step S301, it is determined whether or not there is a cancellation program when a receiving unit 101 receives a processing request for a processing target program for which there is a conflicting program. The “cancellation program” as used herein is a program that cancels conflict with the conflicting program by updating the processing target program or by replacing the processing target program.

Whether or not there is a cancellation program is determined, for example, on the basis of cancellation program presence absence information stored in advance in the apparatus 10 or the server 20. FIG. 10 illustrates, as an example, a table 23 showing the cancellation program presence absence information. It is determined that there is a cancellation program (YES in step S301) in a case where there is a conflicting program for the processing target program and there is a cancellation program for the processing target program.

In a case where it is determined in step S301 that there is a cancellation program (YES in step S301), the processing shifts to step S302.

In step S302, the CPU 11 acquires the cancellation program from the server 20 over the network 50. Then, the CPU 11 shifts the processing to step S303. The cancellation program may be acquired not from the server 20 but from a provider of the processing target program.

In step S303, the CPU 11 receives a processing result of the processing target program for which processing has been executed by the server 20. Then, the CPU 11 shifts the processing to step S304.

In step S304, the CPU 11 updates the program (hereinafter simply referred to as a target program since processing has been completed at this time) by using the cancellation program acquired in step S302. Then, the processing illustrated in FIG. 8 is finished.

Meanwhile, in a case where it is determined in step S301 that there is no cancellation program (NO in step S301), the CPU 11 shifts the processing to step S305.

In step S305, the CPU 11 serving as a controller 102 receives a processing result of the processing target program executed by the server S20. Then, the CPU 11 finishes the processing illustrated in FIG. 8.

By thus acquiring the cancellation program and updating the target program, conflict between the programs does not occur in a case where processing of a similar processing target program is requested next.

Furthermore, since the CPU 11 updates the target program after receiving the processing result of the processing target program, a user need not wait until completion of update of the processing target program as compared with a configuration in which the CPU 11 updates the target program before receiving the processing result of the processing target program.

The target program updating processing in step S304 may be executed at any timing determined in advance. For example, the CPU 11 may execute the updating processing at a timing at which the CPU 11 is activated next time.

### Other Aspects

The information processing apparatuses according to the exemplary embodiments have been described above, but various aspects are possible without departing from the spirit of the present disclosure.

For example, although a single server 20 is provided in the exemplary embodiments, plural servers that correspond to respective functions or processing steps may be provided. In this case, a “version management server” that determines a version of a program and conflict presence absence information, a “processing server” that performs processing of a processing target program, and a “cancellation program providing server” that determines presence or absence of a cancellation program and provides a cancellation program may be separately provided.

The above processing may be realized by a dedicated hardware circuit. In this case, the above processing may be executed by a single piece of hardware or may be executed by plural pieces of hardware.

A program for causing the apparatus 10 to operate may be provided by a computer-readable recording medium such as a universal serial bus (USB) memory, a flexible disc, or a compact disc read only memory (CD-ROM) or may be provided online over a network such as the Internet. In this case, the program recorded on the computer-readable recording medium is typically transferred to and stored in a memory, a storage, or the like. For example, this program may be provided as independent application software or may be incorporated into software of each device as one function of the apparatus 10.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a receiving unit that receives a processing request for a processing target program; and
a controller that receives a processing result of the processing target program processed by an external server in a case where there is a conflicting program that conflicts with the processing target program.

2. The information processing apparatus according to claim 1, wherein
the controller does not execute processing of the processing target program in a case where the controller receives the processing result of the processing target program from the server.

3. The information processing apparatus according to claim 1, wherein
the controller transmits, to the server, list information on a list of the processing target program and programs other than the processing target program.

4. The information processing apparatus according to claim 2, wherein
the controller transmits, to the server, list information on a list of the processing target program and programs other than the processing target program.

5. The information processing apparatus according to claim 3, wherein
the controller transmits the list information to the server when the receiving unit receives the processing request for the processing target program.

6. The information processing apparatus according to claim 4, wherein
the controller transmits the list information to the server when the receiving unit receives the processing request for the processing target program.

7. The information processing apparatus according to claim 5, wherein
in a case where the list information includes a changed program or a newly-introduced program, the controller updates the list information and transmits the updated list information to the server.

8. The information processing apparatus according to claim 6, wherein
in a case where the list information includes a changed program or a newly-introduced program, the controller updates the list information and transmits the updated list information to the server.

9. The information processing apparatus according to claim 1, wherein
the controller transmits, to the server, the processing request for the processing target program that conflicts with the conflicting program.

10. The information processing apparatus according to claim 2, wherein
the controller transmits, to the server, the processing request for the processing target program that conflicts with the conflicting program.

11. The information processing apparatus according to claim 9, wherein
the receiving unit does not receive the processing request for the processing target program in a case where communication with the server is not established.

12. The information processing apparatus according to claim 10, wherein
the receiving unit does not receive the processing request for the processing target program in a case where communication with the server is not established.

13. The information processing apparatus according to claim 11, wherein
the receiving unit visually notifies a user that the receiving unit does not receive the processing request for the processing target program.

14. The information processing apparatus according to claim 12, wherein
the receiving unit visually notifies a user that the receiving unit does not receive the processing request for the processing target program.

15. The information processing apparatus according to claim 1, wherein
the processing target program is one of a plurality of processing programs and the conflicting program is a plurality of conflicting programs, and
in a case where there are the plurality of processing target programs and there are the plurality of conflicting programs respectively for the plurality of processing target programs, the controller transmits processing requests for the plurality of processing target programs to the server and receives processing results of the plurality of processing target programs processed by the server.

16. The information processing apparatus according to claim 1, wherein
in a case where a cancellation program that cancels conflict with the conflicting program is present for the processing target program when the receiving unit receives the processing request for the processing target program, the controller acquires the cancellation program and updates the processing target program by using the cancellation program.

17. The information processing apparatus according to claim 2, wherein
in a case where a cancellation program that cancels conflict with the conflicting program is present for the processing target program when the receiving unit receives the processing request for the processing target program, the controller acquires the cancellation program and updates the processing target program by using the cancellation program.

18. The information processing apparatus according to claim 16, wherein
the controller updates the processing target program by using the cancellation program after receiving the processing result of the processing target program from the server.

19. The information processing apparatus according to claim 18, wherein
the controller updates the processing target program by using the cancellation program when the information processing apparatus is activated.

20. A non-transitory computer readable medium storing a program causing a computer to execute a process, the process comprising:
receiving a processing request for a processing target program; and
receiving a processing result of the processing target program processed by an external server in a case where there is a program that conflicts with the processing target program.
